(19) United States
(12) Patent Application Publication
(10) Pub. No.: US 2026/0254238 A1
(43) Pub. Date: Aug. 27, 2026

(54) CHARACTERISTIC SIGNAL INJECTION METHOD AND DEVICE SUITABLE FOR ACTIVE DETECTION-BASED PROTECTION

(71) Applicant: Nanjing Guodian Nanzhi Power Grid Automation Co., Ltd, Nanjing (CN)

(72) Inventors: Dong CHEN, Nanjing (CN); Fufeng CHEN, Nanjing (CN); Mingjun XUE, Nanjing (CN); Bing HU, Nanjing (CN); Yuping LI, Nanjing (CN); Yinian QI, Nanjing (CN); Changsong QIN, Nanjing (CN); Yuwen LIANG, Nanjing (CN); Cong LI, Nanjing (CN)

(73) Assignee: Nanjing Guodian Nanzhi Power Grid Automation Co., Ltd, Nanjing (CN)

(21) Appl. No.: 19/642,694

(22) Filed: Apr. 9, 2026

Related U.S. Application Data
(63) Continuation of application No. PCT/CN2024/114850, filed on Aug. 27, 2024.

(30) Foreign Application Priority Data
Aug. 31, 2023 (CN) 202311120806X

(51) Int. Cl. H02J 3/001

(52) U.S. Cl. CPC H02J 3/001

(57) ABSTRACT

Provided are a characteristic signal injection method and device suitable for active detection-based protection, which are applied to a distributed power supply. The distributed power supply is connected to a power distribution grid system. The method comprises the following steps: calculating a first characteristic impedance of the system; determining whether the system has had a malfunction; if so, acquiring a second characteristic impedance of the system; determining whether the malfunction has disappeared on the basis of the relationship between the first characteristic impedance and the second characteristic impedance; if the malfunction has disappeared, injecting a pre-set characteristic voltage within a second pre-set duration; and if the malfunction has not disappeared, injecting a pre-set characteristic current into the system, and determining a characteristic signal injection mode for the power distribution grid system on the basis of whether a third characteristic impedance of the system meets a first set condition.

### CROSS-REFERENCE TO RELATED APPLICATIONS

The application claims priority to Chinese patent application No. 202311120806X, filed on Aug. 31, 2023, the entire contents of which are incorporated herein by reference.

### TECHNICAL FIELD

The present disclosure relates to the technical field of relay protection, and in particular to a characteristic signal injection method and device suitable for active detection-based protection, which are applied to a distributed power supply, where the distributed power supply is connected to a power distribution grid system.

### BACKGROUND

With the increasing penetration of distributed power supplies, a large number of flexible and controllable converter devices have appeared in a power distribution grid system, leading to more research and application of active detection-based protection. The distributed power supply injects a characteristic signal, and the active detection-based protection detects the characteristic signal and identifies a malfunction based on changes in the characteristic signal, thereby achieving functions such as malfunction isolation, self-healing, and reclosing.

The active detection-based protection is constructed based on the characteristic signal injected by the converter, and a signal injection control strategy needs to be formulated based on the functional requirements of the active detection-based protection. In existing detection signal injection methods, when a signal is injected into a malfunction, the converter may be blocked due to overcurrent, and accordingly the injection is stopped. This may cause an impact on the converter. Some methods solve the above problem by limiting an injection duration. However, if the injection duration is too short, it cannot support the realization of malfunction isolation and self-healing functions, thereby limiting the scope of application.

Therefore, constructing a reasonable characteristic signal injection method during the active detection-based protection process of a distributed power supply to support malfunction isolation, self-healing, and reclosing functions and prevent overcurrent blocking of the converter is a current problem that needs to be solved.

### SUMMARY

To solve at least one technical problem in the background, the present disclosure provides a characteristic signal injection method and device suitable for active detection-based protection, which are applied to a distributed power supply, where the distributed power supply is connected to a power distribution grid system.

To achieve the above objective, the present disclosure provides a characteristic signal injection method suitable for active detection-based protection, which is applied to a distributed power supply, where the distributed power supply is connected to a power distribution grid system; where the method includes the following steps:
periodically calculating and updating a first characteristic impedance of the system;
a determination step: determining whether the system has had a malfunction; if the system has had a malfunction, acquiring a second characteristic impedance of the system after delaying for a first pre-set duration; and determining whether the malfunction has disappeared on the basis of the relationship between the first characteristic impedance and the second characteristic impedance; where
in the prior art, there are various methods to determine whether a malfunction exists in a power distribution grid system, and the present disclosure does not specifically limit the specific method to be used and does not elaborate on the prior art;
if the malfunction has disappeared, injecting a pre-set characteristic voltage within a second pre-set duration; and
if the malfunction has not disappeared, injecting a pre-set characteristic current into the power distribution grid system and simultaneously acquiring a third characteristic impedance of the system, and determining a characteristic signal injection mode for the system on the basis of whether a third characteristic impedance of the system meets a first set condition.

Preferably, the periodically calculating and updating a first characteristic impedance of the system includes: periodically injecting the pre-set characteristic current into the system, collecting a first characteristic voltage on the system, and calculating and updating the first characteristic impedance Ż₁ based on the pre-set characteristic current and the first characteristic voltage; where

$${\dot{Z}}_{1} = \vert {Z}_{1} \vert {∠φ}_{1} ;$$

the acquiring a second characteristic impedance of the system includes: injecting the pre-set characteristic current into the system, collecting a second characteristic voltage on the system, and calculating the second characteristic impedance Ż₂ based on the pre-set characteristic current and the second characteristic voltage; where Ż₂=Ż₂|Ż∠₂; and
the acquiring a third characteristic impedance Ż of the system includes: periodically injecting the pre-set characteristic current into the system, collecting a third characteristic voltage on the system, and calculating the third characteristic impedance based on the pre-set characteristic current and the third characteristic voltage.

Preferably, the determining whether the malfunction has disappeared on the basis of the relationship between the first characteristic impedance and the second characteristic impedance includes: when the relationship between the first characteristic impedance and the second characteristic impedance satisfies the following inequality, confirming that the malfunction has disappeared,

$$\frac{{\dot{Z}}_{2}}{{\dot{Z}}_{1}} \cdot {\dot{Z}}_{2} \geq \vert {Z}_{2} \vert cos {δ}_{set}$$

in the formula, δₛₑ, represents a pre-set phase angle, with a value ranging from 0 to 45°.

Preferably, the determining a characteristic signal injection mode for the system on the basis of whether a third characteristic impedance of the system meets a first set condition includes:
if it is detected within a second pre-set duration that the third characteristic impedance meets the first set condition, stopping injecting the pre-set characteristic current and switching to injecting the pre-set characteristic voltage; or
otherwise, terminating injecting the characteristic signal and checking a cause of the system malfunction.

Preferably, the first set condition is as follows: |Ż|−|Ż₂₀ₘₛ|>k₄|Ż₂₀ₘₛ|;
in the formula, Ż represents the third characteristic impedance, Ż_{20 ms} represents a characteristic impedance value of the system 20 ms ago, and k₄ represents a fourth pre-set coefficient, with a value ranging from 0.2 to 0.3.

Preferably, the injecting a pre-set characteristic voltage includes: when injecting the pre-set characteristic voltage \dot{U}_{def}, taking an initial voltage \dot{U}₁, and increasing an amplitude in steps of k₂|\dot{U}_{def}, every 20 ms; in the formula, k₂ represents a second pre-set coefficient, with a value of 0.1.

Preferably, the method further includes:
when injecting the characteristic voltage \dot{U}_{def}, collecting the generated characteristic current İ₀ in real time, and when |İ|≥k|₃Ż₁, stopping increasing an amplitude of \dot{U}_{def}; in the formula, k₃ takes a value of 0.95, and İ₁ represents the pre-set characteristic current.

Preferably, the method further includes:
acquiring a real-time load impedance of the system, and when the real-time load impedance meets a second set condition, executing the determination step.

Preferably, the second set condition is as follows: the following formula holds continuously within a duration t/2,

$$\vert \vert {\dot{Z}}_{load} \vert - \vert {\dot{Z}}_{load - t} \vert \vert > {k}_{1} \vert {\dot{Z}}_{load - t} \vert$$

in the formula, Ż_{load} represents the real-time load impedance, Ż_{load-t} represents a real-time load impedance value a duration t ago, k₁ represents a first pre-set coefficient, with a value ranging from 0.2 to 0.3, and t represents a pre-set determination duration, with a value ranging from 10 to 20 min.

Preferably, the determining whether the system has had a malfunction specifically includes: determining whether a voltage or frequency of the system is abnormal.

To achieve the above objective, the present disclosure provides an electronic device, including a processor, a memory, and a computer program stored on the memory and runnable on the processor, where the computer program, when executed by the processor, implements any one of the characteristic signal injection methods suitable for active detection-based protection described above.

Beneficial effects achieved by the present disclosure: In the characteristic signal injection method suitable for active detection-based protection of the present disclosure, different types of characteristic signals are injected based on the malfunction persistence situation, thereby providing characteristic electrical quantities for the active detection-based protection. The present disclosure allows for flexible injection of a distributed power supply characteristic signal, thereby preventing a converter from being blocked due to overcurrent when a signal is injected into a system malfunction, supporting the construction of active detection-based protection, and achieving rapid malfunction isolation, self-healing, as well as safe and reliable reclosing.

### BRIEF DESCRIPTION OF DRAWINGS

FIG. 1 is a typical system diagram of a characteristic signal injection method suitable for active detection-based protection according to an implementation of the present disclosure.

FIG. 2 is a flowchart of a method according to an implementation of the present disclosure.

FIG. 3 is a flowchart of a method according to another implementation of the present disclosure.

### DETAILED DESCRIPTION OF THE EMBODIMENTS

The content of the present disclosure will now be discussed with reference to exemplary embodiments. It should be understood that the discussed embodiments are only for the purpose of enabling those of ordinary skill in the art to better understand and thereby implement the content of the present disclosure, and are not intended to imply any limitation on the scope of the present disclosure.

As used herein, the term “includes” and its variants are to be interpreted as open-ended terms meaning “includes, but is not limited to”. The term “based on” is to be interpreted as “based at least in part on”. The terms “one embodiment” and “an embodiment” are to be interpreted as “at least one embodiment”.

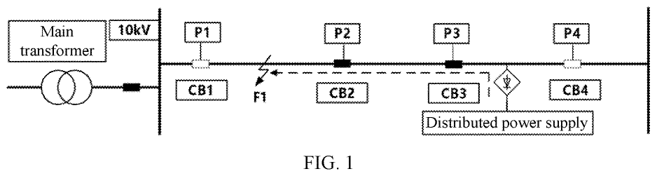

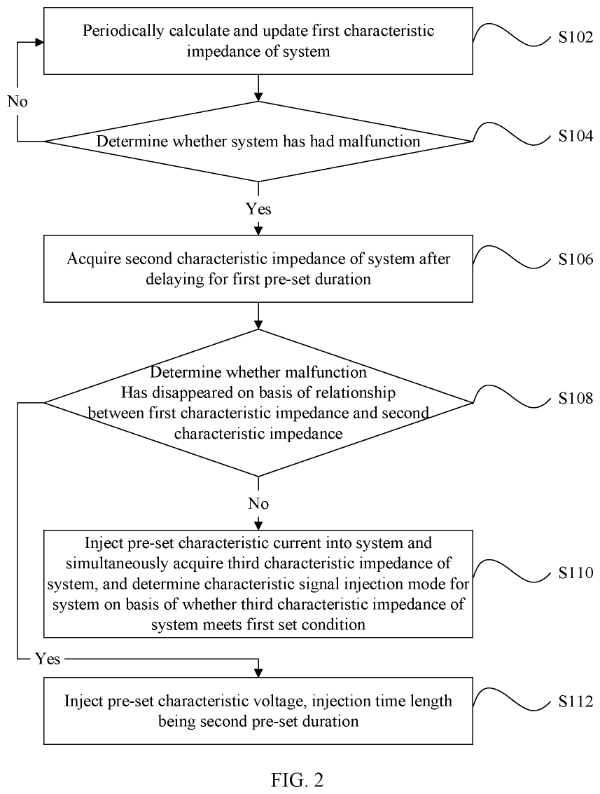

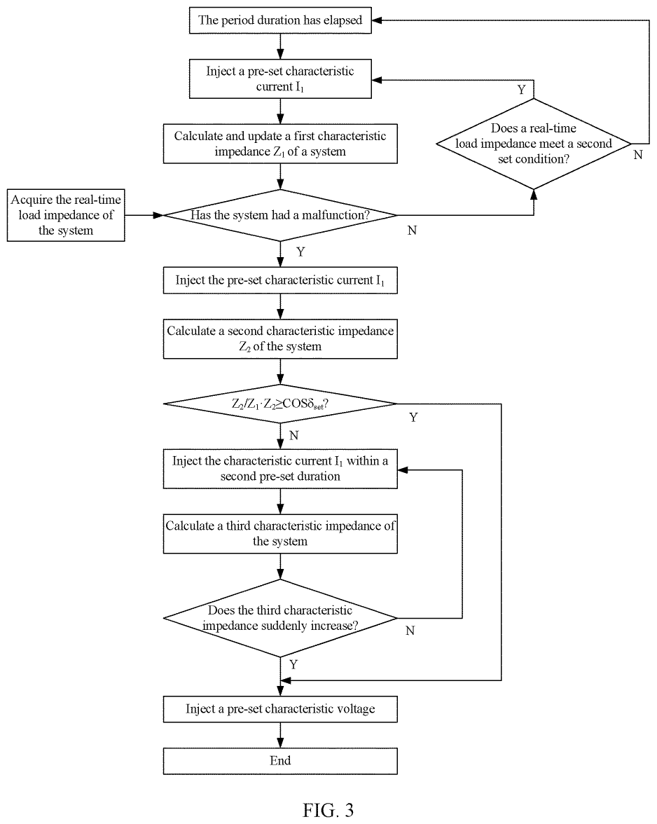

FIG. 1 is a typical system diagram of a characteristic signal injection method suitable for active detection-based protection according to an implementation of the present disclosure; where P1-P4 represent protection devices, CB1-CB4 represent circuit breakers, and F1 represents a malfunction point; and P2 and P3 have an active detection-based isolation function, and P4 represents an open-loop point, and has a self-healing function. FIG. 2 is a flowchart of a method according to an implementation of the present disclosure. FIG. 3 is a flowchart of a method according to another implementation of the present disclosure.

### Embodiment 1

As shown in FIG. 1 to FIG. 3, in this implementation, a characteristic signal injection method suitable for active detection-based protection is applied to a distributed power supply, where the distributed power supply is connected to a power distribution grid system; where the method includes the following steps:

S102, a first characteristic impedance of the system is periodically calculated and updated.

The period is determined according to a variation pattern of a system load. In this implementation, the period may be 4 to 6 h.

S104, it is determined whether the system has had a malfunction; if not, S102 is repeatedly executed; and if yes, S106 is then executed.

In an embodiment of the present disclosure, it may be determined whether the system has had a malfunction by determining whether a voltage or frequency of the system is abnormal; for example, the current system voltage exceeds 20% of a rated voltage, or the deviation of the frequency from a rated frequency (50 Hz) exceeds 2 Hz; and this is the prior art and will not be further elaborated.

S106, a second characteristic impedance of the system is acquired after delaying for a first pre-set duration.

As the system has a reclosing function, the first pre-set duration T₁ needs to consider avoiding an arc extinction duration of a transient malfunction, that is, a value of the first pre-set duration T₁ is not less than a disappearance duration of the transient malfunction, to ensure that when the second characteristic impedance Ż₂ is calculated, the transient malfunction has reliably disappeared, thereby preventing incorrect determination. In this embodiment, T₁ is 1 s to 1.5 s.

S108, it is determined whether the malfunction has disappeared on the basis of the relationship between the first characteristic impedance and the second characteristic impedance; if yes, S112 is executed; and if no, S110 is executed.

S110, a pre-set characteristic current is injected into the system and a third characteristic impedance of the system is simultaneously acquired, and a characteristic signal injection mode for the system is determined on the basis of whether the third characteristic impedance of the system meets a first set condition.

S112, a pre-set characteristic voltage is injected, with an injection time length being a second pre-set duration.

In this embodiment, the pre-set characteristic current İ₁ is a maximum output current designed for a converter to prevent the converter from overcurrent blocking; and to accurately obtain the characteristic impedance of the system, a mode of injecting the pre-set characteristic current İ₁ into the system is short-time injection of the pre-set characteristic current İ₁. In this embodiment, an injection duration for short-time injection of the pre-set characteristic current İ₁ into the system may be 20 ms.

Under the condition of determining that the system has had a malfunction, the present disclosure determines whether the system malfunction has disappeared through the first characteristic impedance in a normal operating state and the second characteristic impedance in a malfunction state; when it is confirmed that the system malfunction has disappeared, the pre-set characteristic voltage is injected to achieve a reclosing function of the active detection-based protection; and when it is confirmed that the system malfunction has not disappeared, the pre-set specific signal is injected to achieve a malfunction isolation function of the active detection-based protection, the third characteristic impedance is acquired, and the characteristic signal injection mode for the system is determined on the basis of the third characteristic impedance. When the third characteristic impedance meets the first set condition, the pre-set characteristic voltage is injected to achieve a self-healing function of the active detection-based protection, and meanwhile, the converter is prevented from being blocked due to overcurrent while the malfunction persists.

Optionally, in another implementation of this embodiment, the converter of the distributed power supply periodically injects a pre-set characteristic current İ₁ into the system, collects a first characteristic voltage \dot{U}₁ on the system, and calculates and updates the first characteristic impedance Ż₁ based on the pre-set characteristic current İ₁ and the first characteristic voltage \dot{U}₁; where

$${\dot{Z}}_{1} = \vert {Z}_{1} \vert {∠φ}_{1} ;$$

after determining that the system has had a malfunction, updating the first characteristic impedance Ż₁ is stopped, the pre-set characteristic current İ₁ is injected into the system after delaying for a first pre-set duration T₁, a second characteristic voltage \dot{U}₂ on the system is collected, and the second characteristic impedance Ż₂ is calculated based on the pre-set characteristic current İ₁ and the second characteristic voltage \dot{U}₂; where

$${\dot{Z}}_{2} = \vert {Z}_{2} \vert {∠φ}_{2} ;$$

if it is determined that the system malfunction has not disappeared, then the pre-set characteristic current İ₁ is injected into the power distribution grid system for a short time, a third characteristic voltage on the system is collected, the third characteristic impedance Ż is calculated based on the pre-set characteristic current İ₁ and the third characteristic voltage, and the characteristic signal injection mode for the distribution network system is determined on the basis of whether the third characteristic impedance Ż meets the first set condition.

In this embodiment, the pre-set characteristic current I₁ is a maximum output current designed for a converter to prevent the converter from overcurrent blocking; and to accurately obtain the characteristic impedance of the system, a mode of injecting the pre-set characteristic current İ₁ into the system is short-time injection of the pre-set characteristic current İ₁. In this embodiment, an injection duration for short-time injection of the pre-set characteristic current İ₁ into the system may be 20 ms.

By taking the pre-set characteristic current as the maximum output current designed for the converter, the present disclosure can effectively prevent the converter from overcurrent blocking; and moreover, the converter injects the same pre-set characteristic current into the system to acquire the first characteristic impedance, the second characteristic impedance, and the third characteristic impedance, respectively. The characteristic impedances acquired based on the same injected signal have better consistency, which can improve the accuracy of determination.

Optionally, in another implementation of this embodiment, S108 specifically includes: when the relationship between the first characteristic impedance Ż₁ and the second characteristic impedance Ż₂ satisfies the following inequality, it is determined that the malfunction has disappeared:

$$\frac{{\dot{Z}}_{2}}{{\dot{Z}}_{1}} \cdot {\dot{Z}}_{2} \geq \vert {Z}_{2} \vert cos {δ}_{set}$$

in the formula, δₛₑₜ represents a pre-set phase angle, with a value ranging from 0 to 45°; or
otherwise, it is determined that the malfunction has not disappeared.

The present disclosure collects the first characteristic impedance during normal operation and the second characteristic impedance after a malfunction has occurred based on the same injected current, and determines whether the malfunction has disappeared through the first characteristic impedance and the second characteristic impedance. The determination method is simple and the identification accuracy is high.

Optionally, in another implementation of this embodiment, in S110, the determining a characteristic signal injection mode for the system on the basis of whether a third characteristic impedance İ meets a first set condition specifically includes:
it is detected within a second pre-set duration T_{cur} whether a third characteristic impedance meets a first set condition; if yes, S1102 is executed; and if no, S1104 is executed.

To prevent protection devices at different levels from operating simultaneously, different operating delays need to be set for the protection devices, which results in the longest operating delay for the protection device at the lowest level. Setting the second pre-set duration T_{cmr} to be greater than the maximum inter-level delay of the system can ensure the reliability of the active detection-based isolation function operation of the protection device, thereby reducing the probability of incorrect determination of the system; and for a typical power distribution grid line, the levels are generally no more than 5 segments, and a level difference of 0.2 s is considered. Therefore, in this implementation, T_{cur} is 1 s.

S1102, injecting the pre-set characteristic current İ₁ is stopped, and it is switched to injecting the pre-set characteristic voltage \dot{U}_{def}.

S1104, injecting the characteristic signal is terminated and a cause of the system malfunction is checked.

In this embodiment, if it is not detected within the maximum inter-level delay T_{cur} of the system that the malfunction has disappeared, it is determined that the system cannot isolate the malfunction and self-heal, injecting the characteristic signal is stopped, and the cause of the system malfunction is checked by other technical means.

When the malfunction has not disappeared, the present disclosure identifies whether the system malfunction has disappeared based on the change in the system characteristic impedance. When the system malfunction has disappeared, it is determined that the transient malfunction is cleared. During the malfunction persistence period, the pre-set characteristic current is continuously injected within the second pre-set duration, and the protection action continues, thereby achieving the isolation function of the active detection-based protection to cut off the malfunction. By setting the second pre-set duration to be not less than the maximum inter-level delay of the system, the present disclosure can reduce the probability of incorrect determination and achieve rapid malfunction isolation and self-healing.

Optionally, in another implementation of this embodiment, in S110, the first set condition is as follows:

$$\vert \dot{Z} \vert - \vert {\dot{Z}}_{20 ms} \vert > {k}_{4} \vert {\dot{Z}}_{20 ms} \vert ;$$

in the formula, Ż represents the third characteristic impedance, Ż_{20 ms} represents a characteristic impedance value of the system 20 ms ago, and k₄ represents a fourth pre-set coefficient, with a value ranging from 0.2 to 0.3.

When the malfunction has not disappeared, the present disclosure identifies whether the system malfunction has disappeared based on the change in the system characteristic impedance, which has the advantages of a simple determination method and a fast identification speed.

Optionally, in another implementation of this embodiment, when the pre-set characteristic voltage \dot{U}_{def} is injected, an initial voltage of the pre-set characteristic voltage is \dot{U}₁, and an amplitude is increased in steps of k₂|\dot{U}_{def} every 20 ms; in the formula, k₂ represents a second pre-set coefficient, with a value of 0.1.

When the pre-set characteristic voltage \dot{U}_{def} is injected, injecting an excessively high voltage should be avoided while the system malfunction is not cleared. Therefore, in this embodiment, |U_{def}| is 5% of a rated voltage, and |U₁| is 0.1 times |\dot{U}_{def}|.

In the process of characteristic voltage injection, through the technical means of gradually increasing the value of the pre-set characteristic voltage, the present disclosure prevents the converter from being blocked due to overcurrent when the signal is injected into the system malfunction, and improves the safety of detection.

Optionally, in another implementation of this embodiment, the characteristic signal injection method suitable for active detection-based protection further includes:
when the characteristic voltage \dot{U}_{def} is injected, the generated characteristic current İ₀ is collected in real time, and when ≡İ₀|≥k₃|İ₁|, increasing an amplitude of \dot{U}_{def} is stopped; in the formula, k₃ represents a third pre-set coefficient, with a value of 0.95, and Î₁ represents the pre-set characteristic current.

In the process of characteristic voltage injection, the present disclosure collects the characteristic current in the system in real time, thereby ensuring that the characteristic current does not exceed the maximum current of the converter, and preventing the converter from overcurrent blocking.

Optionally, in another implementation of this embodiment, the characteristic signal injection method suitable for active detection-based protection further includes:

S101, a real-time load impedance Ż_{load} of the system is acquired, and when the real-time load impedance Ż_{1oad} meets a second set condition, S104 is executed.

In this embodiment, the second set condition is as follows: the following formula holds continuously within a duration t/2,

$$\vert \vert {\dot{Z}}_{load} \vert - \vert {\dot{Z}}_{load - t} \vert \vert > {k}_{1} \vert {\dot{Z}}_{load - t} \vert$$

in the formula, Ż_{1oad} represents the real-time load impedance, Ż_{loadt} represents a real-time load impedance value a duration t ago, k₁ represents a first pre-set coefficient, with a value ranging from 0.2 to 0.3, and t represents a pre-set determination duration, with a value ranging from 10 to 20 min.

The present disclosure performs real-time detection of the system load impedance during the system operating state. When the real-time load impedance changes significantly, the step of malfunction detection on the system is triggered, which can further improve the safety of system operation.

### Embodiment 2

As shown in FIG. 1 to FIG. 3, a characteristic signal injection method suitable for active detection-based protection includes the following steps:

S202, during normal operation of a power distribution grid system, a distributed power supply side periodically injects a pre-set characteristic current İ₁ into the system for a short time, collects a first characteristic voltage \dot{U}₁ on the system, and calculates and updates the first characteristic impedance Ż₁ based on the pre-set characteristic current İ₁ and the first characteristic voltage \dot{U}₁; where

$${\dot{Z}}_{1} = \vert {Z}_{1} \vert {∠φ}_{1} .$$

In this implementation, the period may be 4 to 6 h, an amplitude of the pre-set characteristic current İ₁ is a maximum output current designed for a converter, and an injection duration for short-time injection of the pre-set characteristic current İ₁ into the system is 20 ms.

S204, it is determined whether the system has had a malfunction; if not, S202 is repeatedly executed; and if yes, S206 is then executed.

In this embodiment, the distributed power supply side determines whether the system has had a malfunction by determining whether a voltage or frequency of the system is abnormal; and for example, the current system voltage exceeds 20% of a rated voltage, or the deviation of the frequency from a rated frequency (50 Hz) exceeds 2 Hz.

S206, after determining that the system has had a malfunction, updating the first characteristic impedance Ż, is stopped, and a converter injects the pre-set characteristic current İ₁ into the system after delaying for a first pre-set duration T₁, collects a second characteristic voltage \dot{U}₂ on the system, and calculates the second characteristic impedance Ż₂ based on the pre-set characteristic current İ₁ and the second characteristic voltage \dot{U}₂; where,

$${\dot{Z}}_{2} = \vert {Z}_{2} \vert {∠φ}_{2} .$$

When a malfunction point F1 exists in the system, a circuit breaker CB1 switch is tripped by a conventional protection configured in P1; and the distributed power supply detects that the system voltage or system frequency is abnormal and determines that the system has had a malfunction.

In this embodiment, T₁ may be 1 s to 1.5 s.

S208, it is determined whether the malfunction has disappeared on the basis of the relationship between the first characteristic impedance Ż₁ and the second characteristic impedance Ż₂; if yes, S212 is executed; and if no, S210 is executed.

Specifically, when the relationship between the first characteristic impedance Ż₁ and the second characteristic impedance Ż₂ satisfies the following inequality, it is determined that the malfunction has disappeared:

$$\frac{{\dot{Z}}_{2}}{{\dot{Z}}_{1}} \cdot {\dot{Z}}_{2} \geq \vert {Z}_{2} \vert cos {δ}_{set} ;$$

in the formula, δₛₑₜ represents a pre-set phase angle, with a value ranging from 0 to 45°; or
otherwise, it is determined that the malfunction has not disappeared.

S210, when it is determined that the malfunction at the point F1 has not disappeared, the pre-set characteristic current İ₁ is injected into the system and a third characteristic impedance Ż of the system is acquired simultaneously, and it is detected within a second pre-set duration T_{cur} whether the third characteristic impedance z meets a first set condition, where the first set condition is |Ż|−|Ż_{20 ms}|>k₄|Ż_{20 ms}|;
in the formula, T_{cur} is not less than a maximum inter-level delay of the system, and in this embodiment, T_{cur} is 1 s; and Ż_{20 ms} represents a characteristic impedance value of the system 20 ms ago, and k₄ represents a fourth pre-set coefficient, with a value ranging from 0.2 to 0.3.

At this time, injecting the pre-set characteristic current İ₁ is mainly used for the active detection-based isolation function of P2 and P3 to isolate the malfunction; and after injection for a certain period, the active detection-based isolation function of P2 is satisfied, and a CB2 circuit breaker is tripped. At this time, the characteristic impedance changes from a malfunction impedance to a load impedance.

When it is detected within the second pre-set duration T_{cur} that the third characteristic impedance Ż meets the first set condition, it is determined that |Ż| suddenly increases, indicating that the malfunction has been isolated by the active detection-based isolation function of P2, and S2102 is executed; or otherwise, S2104 is executed.

S2102, injecting the pre-set characteristic current İ₁ is stopped, and it is switched to injecting a pre-set characteristic voltage \dot{U}_{def}.

As a protection device P4 with a self-healing function is located at an open-loop point and cannot acquire the characteristic impedance, it is necessary to switch from injecting the characteristic current to injecting the characteristic voltage, and control a circuit breaker CB4 to close through the protection device P4, thereby achieving the self-healing function of the system.

S2104, injecting a characteristic signal is terminated and a cause of the system malfunction is checked.

If it is not detected within the second pre-set duration that the third characteristic impedance |Ż| meets the first pre-set condition, it is determined that the current system malfunction is not self-healable, and a cause of the system malfunction is checked by other technical means.

S212, the pre-set characteristic voltage \dot{U}_{def} is injected, with an injection time length being a second pre-set duration Tᵥₒₗ.

At this time, it is determined that the malfunction occurring at the malfunction point F1 is a transient malfunction, the malfunction has been cleared, P1 is reclosed, and the system returns to normal operation.

The present disclosure injects different types of characteristic signals based on the malfunction persistence situation, and allows for flexible injection of a distributed power supply characteristic signal, thereby preventing the converter from being blocked due to overcurrent when the characteristic signal is injected into the system malfunction, supporting the construction of active detection-based protection, and achieving rapid malfunction isolation, self-healing, as well as safe and reliable reclosing.

Optionally, in another implementation of this embodiment, the characteristic signal injection method suitable for active detection-based protection further includes:

S201, in the operating state of the distributed power supply, a real-time load impedance Ż_{load} of the system is acquired based on a real-time operating voltage and operating current of the system, and when the real-time load impedance Ż_{load} meets a second set condition, S204 is executed.

In this embodiment, the second set condition is as follows: the following formula holds continuously within a duration t/2,

$$\vert \vert {\dot{Z}}_{load} \vert - \vert {\dot{Z}}_{load - t} \vert \vert > {k}_{1} \vert {\dot{Z}}_{load - t} \vert$$

in the formula, Ż_{load} represents the real-time load impedance, Ż_{load-t} represents a real-time load impedance value a duration t ago, k₁ represents a first pre-set coefficient, with a value ranging from 0.2 to 0.3, and t represents a pre-set determination duration, with a value ranging from 10 to 20 min.

The present disclosure performs real-time detection of the system load impedance during the system operating state. When the real-time load impedance changes significantly, the step of calculating the characteristic impedance of the system is triggered, which can further improve the safety of system operation.

To achieve the above objective, the present disclosure further provides an electronic device, including a processor, a memory, and a computer program stored on the memory and runnable on the processor, where the computer program, when executed by the processor, implements the characteristic signal injection method suitable for active detection-based protection described above.

The present disclosure injects different types of characteristic signals based on the malfunction persistence situation, and provides reasonable characteristic signals for active detection-based protection, which can prevent the converter from being blocked due to overcurrent when the characteristic signal is injected into a system malfunction, support the construction of active detection-based protection, and achieve rapid malfunction isolation, self-healing, as well as safe and reliable reclosing.

Those skilled in the art may clearly understand that for the convenience and conciseness of description, the specific operating processes of the described electronic devices may be referenced to the corresponding processes in the embodiments of the above method, which will not be repeated herein.

The above description is only preferred embodiments of the present application and an explanation of the applied technical principles. Those skilled in the art should understand that the inventive scope involved in the present disclosure is not limited to the technical solutions formed by the specific combination of the above technical features, but also covers other technical solutions formed by any combination of the above technical features or their equivalent features without departing from the inventive concept. For example, technical solutions formed by mutually replacing the above features with (but not limited to) technical features with similar functions disclosed in the present disclosure.

It should be understood that the sequence numbers of the steps in the summary and embodiments of the present disclosure do not imply an absolute order of execution. The execution order of each process should be determined by its function and internal logic, and should not constitute any limitation on the implementation process of the embodiments of the present disclosure.

What is claimed is:

1. A characteristic signal injection method suitable for active detection-based protection, which is applied to a distributed power supply, wherein the distributed power supply is connected to a power distribution grid system; wherein the method comprises the following steps:
periodically calculating and updating a first characteristic impedance of the system;
a determination step: determining whether the system has had a malfunction; if so, acquiring a second characteristic impedance of the system after delaying for a first pre-set duration; and determining whether the malfunction has disappeared on the basis of the relationship between the first characteristic impedance and the second characteristic impedance; wherein
if the malfunction has disappeared, injecting a pre-set characteristic voltage, with an injection time length being a second pre-set duration;
if the malfunction has not disappeared, injecting a pre-set characteristic current into the system and simultaneously acquiring a third characteristic impedance of the system, and determining a characteristic signal injection mode for the system on the basis of whether a third characteristic impedance of the system meets a first set condition.

2. The characteristic signal injection method suitable for active detection-based protection according to claim 1, wherein
the periodically calculating and updating a first characteristic impedance of the system comprises: periodically injecting the pre-set characteristic current into the system, collecting a first characteristic voltage on the system, and calculating and updating the first characteristic impedance Ż₁ based on the pre-set characteristic current and the first characteristic voltage; wherein Ż₁=|Z₁|∠φ₁;
the acquiring a second characteristic impedance of the system comprises: injecting the pre-set characteristic current into the system, collecting a second characteristic voltage on the system, and calculating the second characteristic impedance Ż₂ based on the pre-set characteristic current and the second characteristic voltage; wherein Ż₂=Z₂|∠φ₂; and
the acquiring a third characteristic impedance Ż of the system comprises: periodically injecting the pre-set characteristic current into the system, collecting a third characteristic voltage on the system, and calculating the third characteristic impedance based on the pre-set characteristic current and the third characteristic voltage.

3. The characteristic signal injection method suitable for active detection-based protection according to claim 2, wherein the determining whether the malfunction has disappeared on the basis of the relationship between the first characteristic impedance and the second characteristic impedance comprises: when the relationship between the first characteristic impedance and the second characteristic impedance satisfies the following inequality, determining that the malfunction has disappeared,
$$\frac{{\dot{Z}}_{2}}{{\dot{Z}}_{1}} \cdot {\dot{Z}}_{2} \geq \vert {Z}_{2} \vert cos {δ}_{set}$$
in the formula, δₛₑₜ represents a pre-set phase angle, with a value ranging from 0 to 45°.

4. The characteristic signal injection method suitable for active detection-based protection according to claim 1, wherein the determining a characteristic signal injection mode for the system on the basis of whether a third characteristic impedance of the system meets a first set condition comprises:
if it is detected within a second pre-set duration that the third characteristic impedance meets the first set condition, stopping injecting the pre-set characteristic current and switching to injecting the pre-set characteristic voltage; or
otherwise, terminating injecting the characteristic signal and checking a cause of the system malfunction.

5. The characteristic signal injection method suitable for active detection-based protection according to claim 1, wherein the first set condition is as follows: |Ż|−|Ż_{20 ms}|>k₄|Ż_{20 ms}|;
in the formula, Z represents the third characteristic impedance, Ż_{20 ms} represents a characteristic impedance value of the system 20 ms ago, and k₄ represents a fourth pre-set coefficient, with a value ranging from 0.2 to 0.3.

6. The characteristic signal injection method suitable for active detection-based protection according to claim 1, wherein the injecting a pre-set characteristic voltage comprises: when injecting the pre-set characteristic voltage \dot{U}_{def}, taking an initial voltage \dot{U}₁, and increasing an amplitude in steps of k₂|U_{def}| every 20 ms; in the formula, k₂ represents a second pre-set coefficient, with a value of 0.1.

7. The characteristic signal injection method suitable for active detection-based protection according to claim 6, wherein the method further comprises:
when injecting the characteristic voltage \dot{U}_{def}, collecting the generated characteristic current İ₀ in real time, and when |İ₀|≥k₃İ₁, stopping increasing an amplitude of \dot{U}_{def}; in the formula, k₃ represents a third pre-set coefficient, with a value of 0.95, and İ₁ represents the pre-set characteristic current.

8. The characteristic signal injection method suitable for active detection-based protection according to claim 1, wherein the method further comprises:
acquiring a real-time load impedance of the system, and when the real-time load impedance meets a second set condition, executing the determination step.

9. The characteristic signal injection method suitable for active detection-based protection according to claim 8, wherein the second set condition is as follows: the following formula holds continuously within a duration t/2,
$$\vert \vert {\dot{Z}}_{load} \vert - \vert {\dot{Z}}_{load - t} \vert \vert > {k}_{1} \vert {\dot{Z}}_{load - t} \vert$$
in the formula, Ż_{load} represents the real-time load impedance, Ż_{load-t} represents a real-time load impedance value a duration t ago, k₁ represents a first pre-set coefficient, with a value ranging from 0.2 to 0.3, and t represents a pre-set determination duration, with a value ranging from 10 to 20 min.

10. An electronic device, comprising a processor, a memory, and a computer program stored on the memory and runnable on the processor, wherein the computer program, when executed by the processor, implements the characteristic signal injection method suitable for active detection-based protection according to claim 1.
